(19) United States
(12) Patent Application Publication
(10) Pub. No.: US 2020/0319634 A1
(43) Pub. Date: Oct. 8, 2020

(54) AGENT DEVICE, METHOD OF CONTROLLING AGENT DEVICE, AND STORAGE MEDIUM

(71) Applicant: HONDA MOTOR CO., LTD., Tokyo (JP)

(72) Inventors: Kengo Naiki, Wako-shi (JP); Sawako Furuya, Wako-shi (JP); Yoshifumi Wagatsuma, Wako-shi (JP); Mototsugu Kubota, Wako-shi (JP); Hiroki Nakayama, Wako-shi (JP); Toshikatsu Kuramochi, Tokyo (JP)

(21) Appl. No.: 16/824,876

(22) Filed: Mar. 20, 2020

(30) Foreign Application Priority Data
Mar. 27, 2019 (JP) 2019-059875

(51) Int. Cl. G05D 1/00; G10L 15/22

(52) U.S. Cl. CPC G05D 1/0022; H04W 4/48; G10L 15/22

(57) ABSTRACT

An agent device includes an in-vehicle agent function unit mounted in a vehicle and configured to provide a service including causing an output unit to output a voice response in accordance with speech of a user, an in-vehicle communication unit configured to cause the in-vehicle agent function unit to be connected to a network via an in-vehicle communication device, and a terminal communication unit configured to cause the in-vehicle agent function unit to be connected to the network via a general-purpose terminal. A state in which the in-vehicle agent function unit is connected to the network is selected from a first connection state implemented via the in-vehicle communication unit and a second connection state implemented via the terminal communication unit.

### CROSS-REFERENCE TO RELATED APPLICATION

Priority is claimed on Japanese Patent Application No. 2019-059875, filed Mar. 27, 2019, the content of which is incorporated herein by reference.

### BACKGROUND OF THE INVENTION

### Field of the Invention

The present invention relates to an agent device, a method of controlling the agent device, and a storage medium.

### Description of Related Art

Conventionally, technology related to an agent function for providing information about driving assistance according to a request of an occupant, control of a vehicle, other applications, and the like while interacting with the occupant of the vehicle has been disclosed (Japanese Unexamined Patent Application, First Publication No. 2006-335231).

### SUMMARY OF THE INVENTION

Although information of an agent function is, for example, at least partially transmitted and received between a vehicle and a network through wireless communication, the state of wireless communication may not be stable all the time and contracts and other protocols related to communication also vary with a communication aspect. Thus, when only one communication means is used, unexpected inconvenience may occur and a user may not reliably use the communication means.

Aspects according to the present invention have been made in consideration of such circumstances and an objective of the present invention is to provide an agent device, a method of controlling the agent device, and a storage medium that can provide more reliable support.

To accomplish the objective by solving the above-described problem, the present invention adopts the following aspects.

(1): According to an aspect of the present invention, there is provided an agent device including: an in-vehicle agent function unit mounted in a vehicle and configured to provide a service including causing an output unit to output a voice response in accordance with speech of a user; an in-vehicle communication unit configured to cause the in-vehicle agent function unit to be connected to a network via an in-vehicle communication device; and a terminal communication unit configured to cause the in-vehicle agent function unit to be connected to the network via a general-purpose terminal, wherein a state in which the in-vehicle agent function unit is connected to the network is selected from a first connection state implemented via the in-vehicle communication unit and a second connection state implemented via the terminal communication unit.

(2): In the above-described aspect (1), a terminal agent function unit configured to provide a service including causing an output unit to output a voice response using hardware of the general-purpose terminal in accordance with the speech of the user may be mounted in the general-purpose terminal and the terminal communication unit may cause the in-vehicle agent function unit to be connected to the network via the terminal agent function unit of the general-purpose terminal.
(3): In the above-described aspect (2), the in-vehicle agent function unit and the terminal agent function unit may be able to perform communication within the vehicle or via each other's parent server.

(4): In the above-described aspect (3), the in-vehicle agent function unit and the terminal agent function unit may transmit and receive information through short-range wireless communication.

(5): In any one of the above-described aspects (1) to (4), information provided via the network may be provided to the in-vehicle agent function unit via the terminal communication unit when the second connection state has been selected.

(6): In any one of the above-described aspects (1) to (5), one of the first connection state and the second connection state having a higher radio wave intensity may be selected.

(7): In any one of the above-described aspects (1) to (5), one of the first connection state and the second connection state may be selected in accordance with a location of the vehicle.

(8): In any one of the above-described aspects (1) to (5), one of the first connection state and the second connection state may be selected on the basis of an amount of communication of the first connection state.

(9): In the above-described aspect (8), the second connection state may be selected when the amount of communication of the first connection state exceeds a predetermined amount of communication.

(10): In any one of the above-described aspects (1) to (5), the first connection state and the second connection state may be selected on the basis of designation of the user.

(11): In any one of the above-described aspects (1) to (10), it may be presented whether the state in which the in-vehicle agent function unit is connected to the network is the first connection state or the second connection state.

(12): In any one of the above-described aspects (1) to (11), the user may be prompted to charge the general-purpose terminal when the second connection state is selected as the state in which the in-vehicle agent function unit is connected to the network.

(13): According to an aspect of the present invention, there is provided a method of controlling an agent device, the method including: activating, by a computer, an in-vehicle agent function unit mounted in a vehicle and a terminal agent function unit mounted in a general-purpose terminal; enabling, by the computer, the in-vehicle agent function unit to be connected to a network via an in-vehicle communication device; enabling, by the computer, the in-vehicle agent function unit to be connected to the network via the general-purpose terminal; and selecting, by the computer, a state in which the in-vehicle agent function unit is connected to the network from a first connection state implemented via an in-vehicle communication unit and a second connection state implemented via a terminal communication unit.

(14): According to an aspect of the present invention, there is provided a computer-readable non-transitory storage medium storing a program for causing a computer to execute: a process of activating an in-vehicle agent function unit mounted in a vehicle and a terminal agent function unit mounted in a general-purpose terminal; a process of enabling the in-vehicle agent function unit to be connected to a network via an in-vehicle communication device; a process of enabling the in-vehicle agent function unit to be connected to the network via the general-purpose terminal; and a process of selecting a state in which the in-vehicle agent function unit is connected to the network from a first connection state implemented via an in-vehicle communication unit and a second connection state implemented via a terminal communication unit.

According to the aspects of the present invention, it is possible to provide more reliable support.

### BRIEF DESCRIPTION OF THE DRAWINGS

FIG. 1 is a configuration diagram of an agent system including an agent device.

FIG. 2 is a diagram showing a configuration of an agent device and equipment mounted in a vehicle according to a first embodiment.

FIG. 3 is a diagram showing an example of an arrangement of a display and operation device.

FIG. 4 is a diagram showing an example of an arrangement of a speaker unit.

FIG. 5 is a diagram for describing the principle of determining a position where a sound image is localized.

FIG. 6 is a diagram showing a configuration of an in-vehicle agent server and a part of the configuration of the agent device.

FIG. 7 is a diagram showing an example of a configuration of a general-purpose communication terminal including a terminal agent device.

FIG. 8 is a flowchart showing an example of a flow of a process to be executed in the agent device.

FIG. 9 is a flowchart showing an example of a flow of a process to be executed in the agent device.

FIG. 10 is a flowchart showing an example of a flow of a process to be executed in the agent device.

FIG. 11 is a flowchart showing an example of a flow of a process to be executed in the agent device.

FIG. 12 is a flowchart showing an example of a flow of a process to be executed in the agent device.

FIG. 13 is a diagram for describing an example of a state of information transmission and reception between the agent device and the agent server.

### DETAILED DESCRIPTION OF THE INVENTION

Hereinafter, an embodiment of an agent device, a method of controlling the agent device, and a storage medium according to the present invention will be described with reference to the drawings. The agent device is a device for implementing a part or all of an agent system. Hereinafter, an agent device mounted in a vehicle (hereinafter referred to as a vehicle M) and having a plurality of types of agent functions will be described as an example of the agent device. The agent function is, for example, a function of providing various types of information based on a request (a command) included in speech of an occupant while interacting with the occupant who is a user of the vehicle M and mediating a network service. A plurality of types of agents may have different functions to be performed, different processing procedures, different control, and different output modes and details. The agent functions may include a function of controlling equipment within the vehicle (for example, equipment related to driving control and vehicle body control) and the like.

In addition to, for example, a voice recognition function for recognizing the occupant's voice (a function of converting voice into text), the agent functions are implemented by generally employing a natural language processing function (a function of understanding the structure and meaning of text), an interaction management function, a network search function of searching for another device via a network or a predetermined database on the same device, and the like. Some or all of these functions may be implemented by artificial intelligence (AI) technology. A part of the configuration in which these functions (particularly, a voice recognition function and a natural language processing/interpretation function) are performed may be mounted in an agent server (an external device) capable of communicating with an in-vehicle communication device of the vehicle M or a general-purpose communication device MT brought into the vehicle M, for example, an in-vehicle agent server 200 and a terminal agent server 400. In the following description, it is assumed that a part of the configuration is mounted in the agent server and the agent device and the agent server cooperate to implement an agent system. It is assumed that the agent device and the agent server cooperate to implement an agent system. A service providing entity (a service entity) that is allowed to virtually appear by the agent device and the agent server in cooperation is referred to as an agent.

### <Overall Configuration>

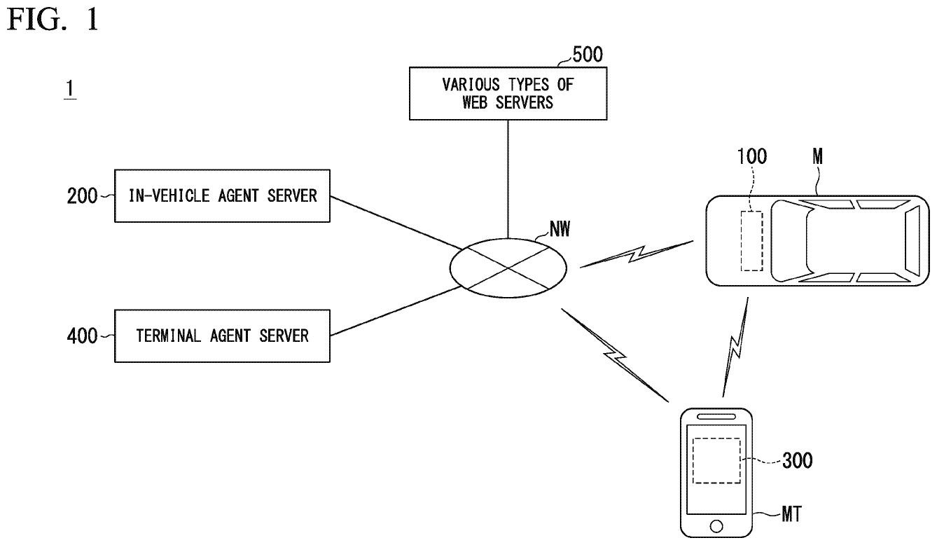

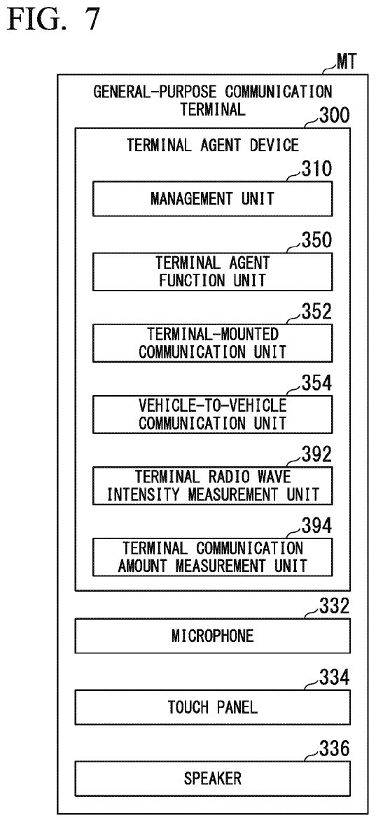

FIG. 1 is a configuration diagram of an agent system 1 including an agent device 100. The agent system 1 includes, for example, the agent device 100, the in-vehicle agent server 200, and the terminal agent server 400. The in-vehicle agent server 200 and the terminal agent server 400 are operated by providers of agent systems different from each other. Accordingly, the agents in the present invention are operated by the providers of the agent systems different from each other. The agent device 100 is provided by a provider of an agent system having the in-vehicle agent server 200 and a terminal agent device 300 is provided by a provider of an agent system having the terminal agent server 400. The in-vehicle agent server 200 is a parent server of an in-vehicle agent function unit 150 and the terminal agent server 400 is a parent server of a terminal agent function unit 350 (see FIG. 7). The provider of the agent system includes, for example, an automobile manufacturer, a network service provider, an e-commerce provider, a mobile terminal seller and a manufacturer, and the like. Any entity (a corporation, an organization, an individual, or the like) may become a provider of the agent system.

The agent device 100 communicates with the in-vehicle agent server 200 via a network NW. The network NW includes, for example, some or all of the Internet, a cellular network, a Wi-Fi network, a wide area network (WAN), a local area network (LAN), a public circuit, a telephone circuit, a wireless base station, and the like. Various types of web servers 500 are connected to the network NW. The agent device 100, the in-vehicle agent server 200, the terminal agent device 300, and the terminal agent server 400 can acquire web pages from the various types of web servers 500 via any network NW.

The agent device 100 interacts with the occupant of the vehicle M, transmits voice from the occupant to the in-vehicle agent server 200, and presents a response obtained from the in-vehicle agent server 200 to the occupant in the form of voice output or image display. The agent device 100 transmits information of voice based on an interaction with the occupant to the terminal agent device 300. The terminal agent device 300 communicates with the terminal agent server 400 via the network NW. The terminal agent device 300 is mounted in a general-purpose terminal. The terminal agent device 300 interacts with a user of a general-purpose communication terminal MT, transmits voice from the occupant to the terminal agent server 400, and outputs a response obtained from the terminal agent server 400 to the user in the form of voice output or image display. Further, the terminal agent device 300 transmits information of the voice transmitted by the agent device 100 to the terminal agent server 400 and transmits information of the response obtained from the terminal agent server 400 to the agent device 100. When the general-purpose communication terminal MT is brought into the vehicle M by the user, for example, the user of the general-purpose communication terminal MT becomes the occupant of the vehicle M.

### First Embodiment

### [Vehicle]

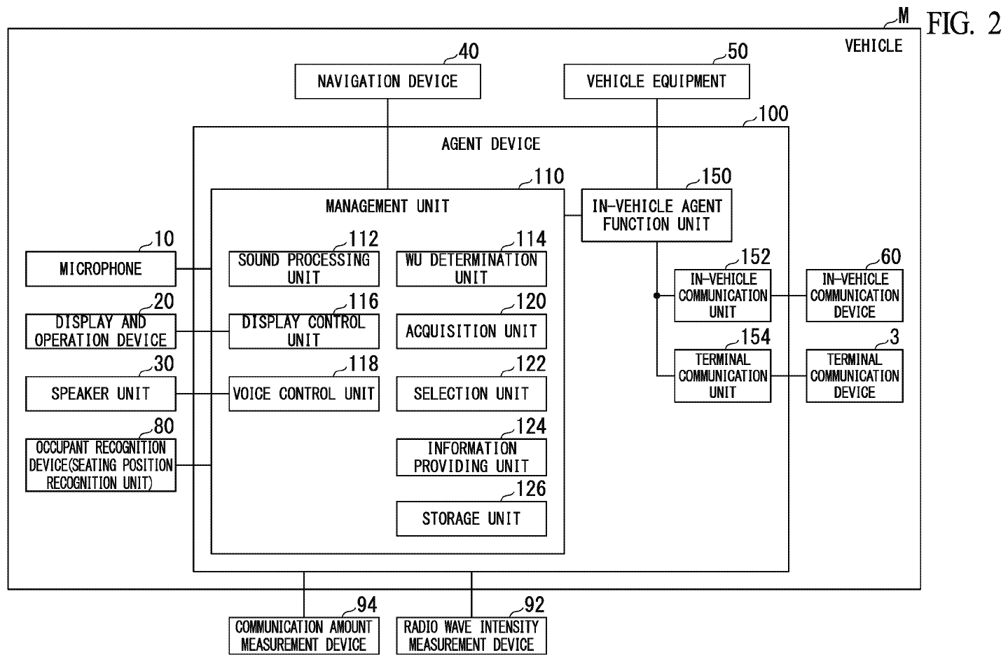

FIG. 2 is a diagram showing a configuration of the agent device 100 and equipment mounted in the vehicle M according to the first embodiment. In the vehicle M, for example, one or more microphones 10, a display and operation device 20, a speaker unit 30, a navigation device 40, vehicle equipment 50, an in-vehicle communication device 60, an occupant recognition device 80, a radio wave intensity measurement device 92, a communication amount measurement device 94, and an agent device 100 are mounted. In some cases, the general-purpose communication terminal MT such as a smartphone is brought into the interior of the vehicle and used as a communication device. These devices are mutually connected by a multiplex communication line or a serial communication line such as a controller area network (CAN) communication line, a wireless communication network, or the like. The configuration shown in FIG. 2 is merely an example and parts of the configuration may be omitted or other configurations may be added.

The microphone 10 is a sound collection unit configured to collect voice emitted in the interior of the vehicle. The display and operation device 20 is a device (or a device group) that can display an image and accept an input operation. The display and operation device 20 includes, for example, a display device configured as a touch panel. The display and operation device 20 may further include a head up display (HUD) or a mechanical input device. The speaker unit 30 includes, for example, a plurality of speakers (sound output units) arranged at different positions in the interior of the vehicle. The display and operation device 20 may be shared by the agent device 100 and the navigation device 40. These will be described in detail below.

The navigation device 40 includes a navigation human machine interface (HMI), a positioning device such as a global positioning system (GPS) device, a storage device that stores map information, and a control device (a navigation controller) for searching for a route and the like. Some or all of the microphone 10, the display and operation device 20, and the speaker unit 30 may be used as a navigation HMI. The navigation device 40 searches for a route (a navigation route) for moving from a position of the vehicle M specified by the positioning device to a destination input by the occupant and outputs guidance information using the navigation HMI so that the vehicle M can travel along the route.

A route search function may be provided in a navigation server accessible via the network NW. In this case, the navigation device 40 acquires a route from the navigation server and outputs guidance information. The agent device 100 may be constructed on the basis of the navigation controller. In this case, the navigation controller and the agent device 100 are integrally configured on hardware. The navigation device 40 transmits a location of the vehicle M and map information stored in the storage device to the agent device 100. The map information includes information of a radio wave intensity map indicating a distribution of radio wave intensities (hereinafter referred to as vehicle radio wave intensities) of the in-vehicle communication device 60 at points. The navigation device 40 transmits the location information of the vehicle M and the map information to the agent device 100 at a predetermined timing, for example, at a timing when the distribution of radio wave intensities at the location of the vehicle M changes. The navigation device 40 may transmit information of the radio wave intensity at the location of the vehicle M instead of or in addition to the location information and the map information of the vehicle M.

The vehicle equipment 50 includes, for example, a driving force output device such as an engine or a travel motor, an engine starting motor, a door lock device, a door opening/closing device, windows, a window opening/closing device, a window opening/closing control device, seats, a seat position control device, a rearview mirror and its angular position control device, lighting devices inside and outside the vehicle and their control device, a wiper or a defogger and its control device, a direction indicator and its control device, an air conditioner, a vehicle information device for information about a travel distance and a tire air pressure and information about the remaining amount of fuel, and the like.

The in-vehicle communication device 60 is a wireless communication device capable of accessing the network NW using, for example, a cellular network or a Wi-Fi network.

The occupant recognition device 80 includes, for example, a seating sensor, a vehicle interior camera, an image recognition device, and the like.

The seating sensor includes a pressure sensor provided below a seat, a tension sensor attached to a seat belt, and the like. The vehicle interior camera is a charge coupled device (CCD) camera or a complementary metal oxide semiconductor (CMOS) camera provided in the interior of the vehicle. The image recognition device analyzes an image of the vehicle interior camera and recognizes the presence/absence of an occupant for each seat, the face direction, and the like.

The radio wave intensity measurement device 92 is a device that measures an in-vehicle radio wave intensity. The radio wave intensity measurement device 92 transmits information of the measured radio wave intensity to the agent device 100. The communication amount measurement device 94 is a device that measures an amount of communication of the in-vehicle communication device 60. The communication amount measurement device 94 transmits information of the measured amount of communication to the agent device 100.

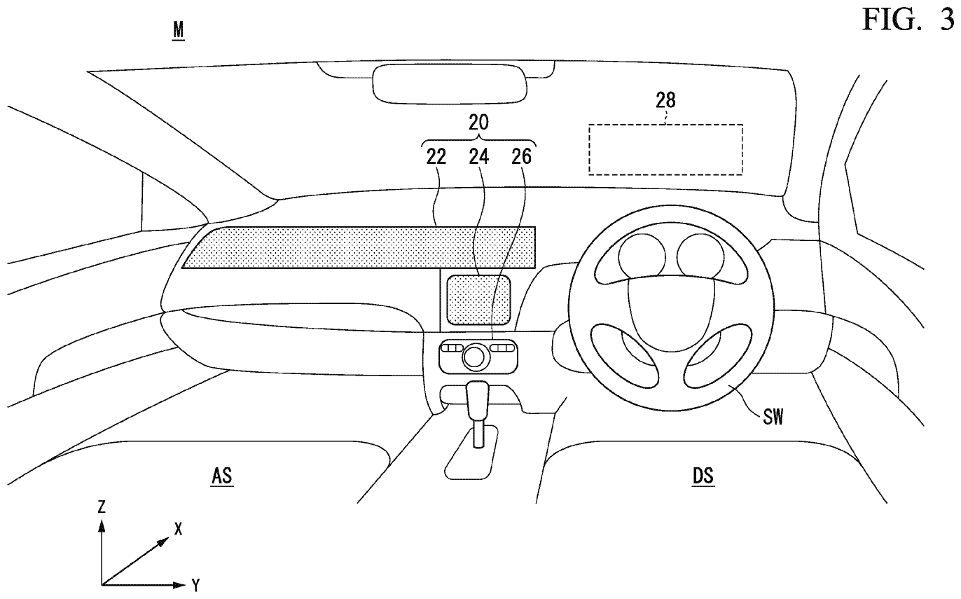

FIG. 3 is a diagram showing an example of the arrangement of the display and operation device 20. The display and operation device 20 may include, for example, a first display 22, a second display 24, and an operation switch ASSY 26. The display and operation device 20 may further include an HUD 28.

The vehicle M includes, for example, a driver seat DS provided with a steering wheel SW and a passenger seat AS provided in a vehicle width direction (a Y-direction in FIG. 3) with respect to the driver seat DS. The first display 22 is a horizontally long display device that extends from around the midpoint between the driver seat DS and the passenger seat AS on an instrument panel to a position facing a left end of the passenger seat AS.

The second display 24 is present at an intermediate position between the driver seat DS and the passenger seat AS in the vehicle width direction and is installed below the first display 22. For example, both the first display 22 and the second display 24 are configured as a touch panel and a liquid crystal display (LCD), an organic electroluminescence (EL), a plasma display, or the like is included as the display. The operation switch ASSY 26 has a form in which a dial switch, a button switch, and the like are integrated. The display and operation device 20 outputs details of an operation performed by the occupant to the agent device 100. Details displayed on the first display 22 or the second display 24 may be determined by the agent device 100.

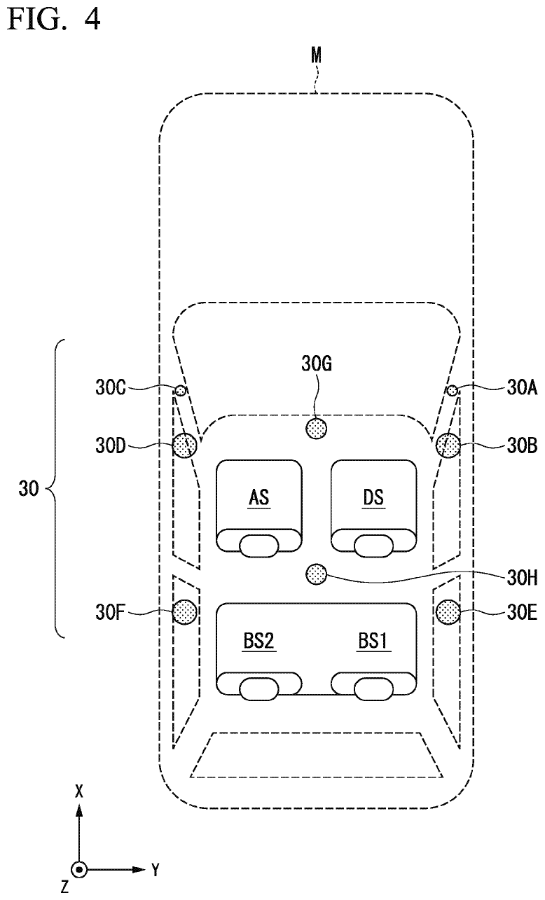

FIG. 4 is a diagram showing an example of an arrangement of the speaker unit 30. The speaker unit 30 includes, for example, speakers 30A to 30H. The speaker 30A is installed on a window post (so-called A pillar) on the driver seat DS side. The speaker 30B is installed below the door near the driver seat DS. The speaker 30C is installed on a window post on the passenger seat AS side. The speaker 30D is installed below the door near the passenger seat AS. The speaker 30E is installed below the door near a right rear seat BS1 side. The speaker 30F is installed below the door near a left rear seat BS2 side. The speaker 30G is installed near the second display 24. The speaker 30H is installed on the ceiling (roof) of the interior of the vehicle.

For example, when sounds are exclusively output from the speakers 30A and 30B in such an arrangement, sound images are localized near the driver seat DS. When sounds are exclusively output from the speakers 30C and 30D, sound images are localized near the passenger seat AS. When a sound is exclusively output from the speaker 30E, a sound image is localized near the right rear seat BS1. When a sound is exclusively output from the speaker 30F, a sound image is localized near the left rear seat BS2. When a sound is exclusively output from the speaker 30G, a sound image is localized near the front of the interior of the vehicle. When a sound is exclusively output from the speaker 30H, a sound image is localized near the upper portion of the interior of the vehicle. The present invention is not limited to the above and the speaker unit 30 can cause the sound image to be localized at any position in the interior of the vehicle by adjusting a distribution of sounds output from the speakers using a mixer or an amplifier.

### [Agent Device]

Returning to FIG. 2, the agent device 100 includes a management unit 110, an in-vehicle agent function unit 150, an in-vehicle communication unit 152, and a terminal communication unit 154. The management unit 110 includes, for example, a sound processing unit 112, a wake up (WU) determination unit 114, a display control unit 116, a voice control unit 118, an acquisition unit 120, a selection unit 122, and an information providing unit 124, and a storage unit 126. The software arrangement shown in FIG. 2 is simply shown for ease of description. Actually, for example, it is possible to arbitrarily make modifications so that the management unit 110 may be interposed between the in-vehicle agent function unit 150 and the in-vehicle communication device 60.

The components of the agent device 100 are implemented, for example, by a hardware processor such as a central processing unit (CPU) executing a program (software). Some or all of these components are implemented by hardware (a circuit including circuitry) such as large scale integration (LSI), an application specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or a flash memory or may be stored in a removable storage medium (the non-transitory storage medium) such as a DVD or a CD-ROM and installed when the storage medium is mounted in a drive device. The storage unit 126 is implemented by the above-described storage device.

The management unit 110 functions by executing a program such as an operating system (OS) or middleware.

The sound processing unit 112 of the management unit 110 performs sound processing on an input sound so that the agent device 100 is in a state suitable for recognizing a preset wake-up word.

The WU determination unit 114 recognizes a wake-up word that is predetermined for the agent device 100. The WU determination unit 114 recognizes the meaning of a sound from voice (a voice stream) subjected to sound processing. First, the WU determination unit 114 detects a voice section on the basis of the amplitude and the zero crossing of a voice waveform in the voice stream. The WU determination unit 114 may perform section detection based on voice identification and non-voice identification in units of frames based on a Gaussian mixture model (GMM).

Next, the WU determination unit 114 converts voice in the detected voice section into text and generates text information. Then, the WU determination unit 114 determines whether or not the text information corresponds to a wake-up word. When it is determined that the text information is a wake-up word, the WU determination unit 114 causes the in-vehicle agent function unit 150 to be activated. A function corresponding to the WU determination unit 114 may be mounted in the in-vehicle agent server 200. In this case, the management unit 110 transmits a voice stream on which sound processing has been performed by the sound processing unit 112 to the in-vehicle agent server 200. When the in-vehicle agent server 200 determines that the text information is a wake-up word, the in-vehicle agent function unit 150 is activated in accordance with an instruction from the in-vehicle agent server 200. The in-vehicle agent function unit 150 may be activated all the time and may determine the wake-up word on its own. In this case, the management unit 110 does not need to include the WU determination unit 114.

The display control unit 116 causes the first display 22 or the second display 24 to display an image in accordance with an instruction from the in-vehicle agent function unit 150. Hereinafter, the first display 22 is assumed to be used. Under the control of the in-vehicle agent function unit 150, the display control unit 116 generates, for example, an image of an anthropomorphized agent that communicates with the occupant in the interior of the vehicle (hereinafter referred to as an agent image) and causes the first display 22 to display the generated agent image. The agent image is, for example, an image in an aspect of talking to the occupant. The agent image may include, for example, at least a face image whose face expression and face direction are recognized by a viewer (an occupant). For example, in the agent image, parts obtained by simulating eyes and a nose of the agent are represented in the face area and the face expression and the face direction may be recognized on the basis of the positions of the parts in the face area. The agent image may be three-dimensionally perceived and the viewer may recognize the agent's face direction by including a head image in a three-dimensional space or recognize the agent's movement, behavior, attitude, and the like by including an image of a main body (a body, hands, and feet) of the agent. The agent image may be an animation image.

The voice control unit 118 causes voices to be output to some or all of the speakers included in the speaker unit 30 in accordance with an instruction from the in-vehicle agent function unit 150. The voice control unit 118 may use a plurality of speaker units 30 to perform control for causing a sound image of the agent voice to be localized at a position corresponding to the display position of the agent image. The position corresponding to the display position of the agent image is, for example, a position where the occupant is expected to perceive that the agent image is speaking in the agent voice, specifically, a position corresponding to the position near the display position of the agent image (for example, within 2 to 3 [cm]). Localizing the sound image includes, for example, determining a spatial position of the sound source perceived by the occupant by adjusting the magnitude of the sound transferred to the left and right ears of the occupant.

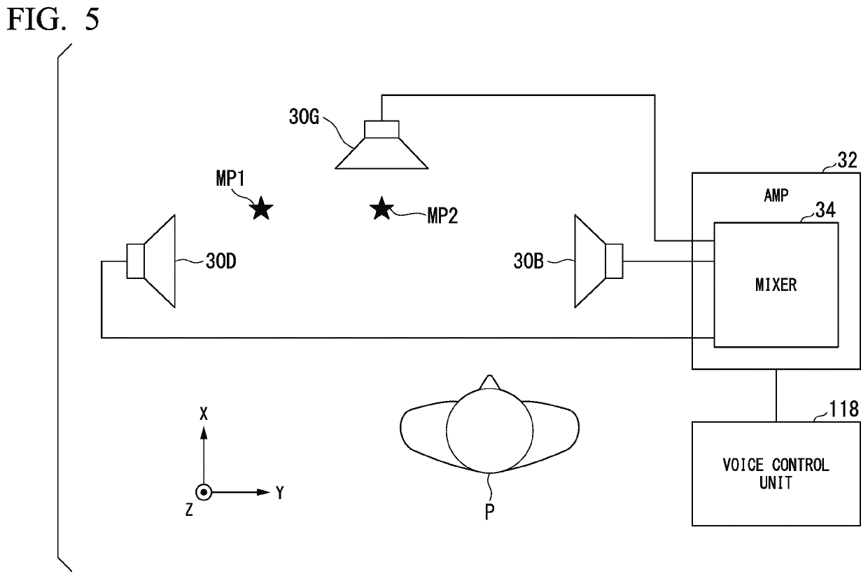

FIG. 5 is a diagram for describing the principle of determining the position where the sound image is localized. Although an example in which the above-described speakers 30B, 30D, and 30G are used for simplification of description is shown in FIG. 5, any speaker included in the speaker unit 30 may be used. The voice control unit 118 controls an amplifier (AMP) 32 and a mixer 34 connected to each speaker to cause a sound image to be localized. For example, when the sound image is localized at a spatial position MP1 shown in FIG. 5, the voice control unit 118 controls the amplifier 32 and the mixer 34 so that the amplifier 32 and the mixer 34 cause the speaker 30B to perform an output of 5% of a maximum intensity, cause the speaker 30D to perform an output of 80% of the maximum intensity, and cause the speaker 30G to perform an output of 15% of the maximum intensity. As a result, from the position of the occupant P, it is perceived as if the sound image is localized at the spatial position MP1 shown in FIG. 5.

When the sound image is localized at the spatial position MP2 shown in FIG. 5, the voice control unit 118 controls the amplifier 32 and the mixer 34 to cause the speaker 30B to output 45% of the maximum intensity, cause the speaker 30D to output 45% of the maximum intensity, and cause the speaker 30G to output 45% of the maximum intensity. As a result, from the position of the occupant P, it is perceived that the sound image is localized at the spatial position MP2 shown in FIG. 5. In this manner, a position at which the sound image is localized can be changed by adjusting the plurality of speakers provided in the interior of the vehicle and the magnitude of the sound output from each speaker. More specifically, because the position at which the sound image is localized is determined on the basis of sound characteristics inherently possessed by a sound source, information of a vehicle interior environment, and a head-related transfer function (HRTF), the voice control unit 118 causes the sound image to be localized at a predetermined position by controlling the speaker unit 30 with an optimum output distribution obtained in advance by a sensory test or the like.

The acquisition unit 120 acquires various types of information transmitted by the display and operation device 20, the in-vehicle communication unit 152, the terminal communication unit 154, the radio wave intensity measurement device 92, and the communication amount measurement device 94. The acquisition unit 120 stores the acquired information in the storage unit 126.

The selection unit 122 reads various types of information acquired by the acquisition unit 120 from the storage unit 126, and selects the connection state of the agent device 100 from the first connection state and the second connection state on the basis of the read information. Each of the first connection state and the second connection state is an aspect of the connection state of the agent device 100 that is a state in which the in-vehicle agent function unit 150 is connected to the network NW. The first connection state is a connection state in which a connection between the in-vehicle agent function unit 150 and the network NW is implemented via the in-vehicle communication unit 152 and the second connection state is a connection state in which a connection between the in-vehicle agent function unit 150 and the network NW is implemented via the terminal communication unit 154. When the second connection state is selected, the information provided by the terminal agent server 400 via the network NW is provided to the in-vehicle agent function unit 150 via the terminal communication unit 154. The selection unit 122 stores information of the selected connection state in the storage unit 126 and outputs the information to the in-vehicle agent function unit 150. The in-vehicle agent function unit 150 is connected to the network NW in the connection state selected by the selection unit 122.

The information providing unit 124 reads the information of the connection state of the agent device 100 stored in the storage unit 126 and outputs the information of the read connection state of the agent device 100 to the display control unit 116 and the voice control unit 118. The display control unit 116 controls the display and operation device 20 on the basis of the output information of the connection state of the agent device 100 and causes the first display 22 or the second display 24 to display the current connection state. For example, when the connection state of the agent device 100 is the first connection state, the display control unit 116 causes the first display 22 or the second display 24 to display text, a symbol, or the like indicating the in-vehicle agent server 200 of a connection destination. When the connection state of the agent device 100 is the second connection state, the display control unit 116 causes the first display 22 or the second display 24 to display text, a symbol, or the like indicating the terminal agent server 400 of a connection destination. For example, the voice control unit 118 causes the speaker unit 30 to output the current connection state. Thus, the information providing unit 124 presents the information of the connection state to the occupant.

The in-vehicle agent function unit 150 causes an agent to appear in cooperation with the in-vehicle agent server 200 by executing an in-vehicle application program (hereinafter, an in-vehicle agent application) for providing a service including a voice response and provides a service including a voice response in accordance with speech of the occupant of the vehicle. The in-vehicle agent function units 150 may include one to which authority to control the vehicle equipment 50 has been given.

The in-vehicle agent function unit 150 is connectable to the network NW and is connected to the network NW in the first connection state or the second connection state selected by the selection unit 122. The in-vehicle agent function unit 150 outputs information of a designation request instruction for allowing the user to designate the connection state of the agent device 100 to the management unit 110. The management unit 110 causes the display and operation device 20 to display information for designating the connection state in the display control unit 116 on the basis of the information of the designation request instruction output by the in-vehicle agent function unit 150. The display and operation device 20 outputs information of a designation result for information for designating the displayed connection state to the selection unit 122. The selection unit 122 selects the connection state of the agent device 100 on the basis of the output information of the designation result, for example, when the information of the designation result has been output by the display and operation device 20.

The in-vehicle communication unit 152 connects the in-vehicle agent function unit 150 and the in-vehicle communication device 60 when the connection state of the agent device 100 is the first connection state. The in-vehicle communication unit 152 causes the in-vehicle agent function unit 150 to be connected to the network NW via the in-vehicle communication device 60. The in-vehicle communication unit 152 transmits information output by the in-vehicle agent function unit 150 to the in-vehicle communication device 60. The in-vehicle communication unit 152 outputs information transmitted by the in-vehicle communication device 60 to the in-vehicle agent function unit 150.

For example, the terminal communication unit 154 performs pairing with the general-purpose communication terminal MT through short-range wireless communication such as Bluetooth (registered trademark) by executing the pairing application and causes the in-vehicle agent function unit 150 and the general-purpose communication terminal MT to be connected. The terminal communication unit 154 causes the in-vehicle agent function unit 150 to be connected to the network NW via the terminal agent function unit 350 (see FIG. 7) of the general-purpose communication terminal MT. The terminal communication unit 154 connects the in-vehicle agent function unit 150 and the general-purpose communication terminal MT when the connection state of the agent device 100 is the second connection state. The terminal communication unit 154 transmits information output by the in-vehicle agent function unit 150 to the general-purpose communication terminal MT. The terminal communication unit 154 outputs information transmitted by the general-purpose communication terminal MT, for example, response information, to the in-vehicle agent function unit 150.

The in-vehicle agent function unit 150 may be configured to be connected to the general-purpose communication terminal MT through wired communication using a universal serial bus (USB) or the like.

### [In-Vehicle Agent Server]

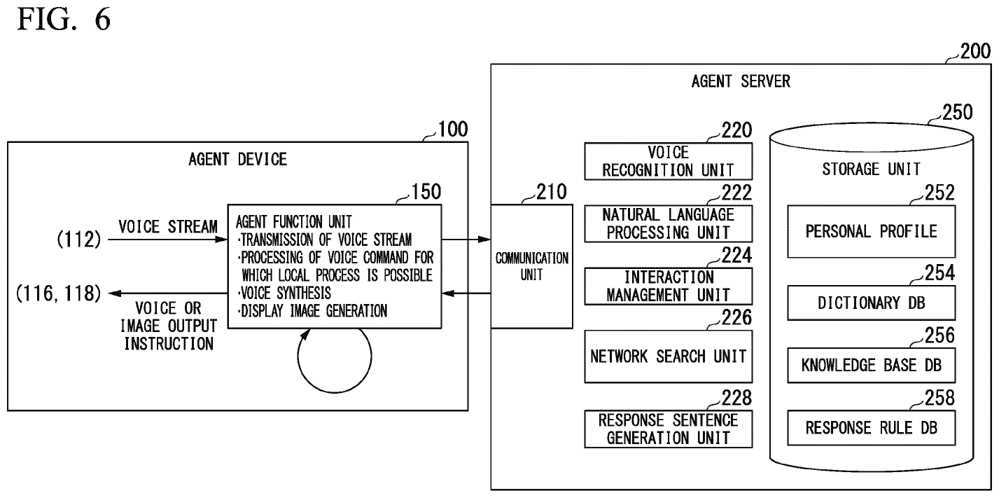

FIG. 6 is a diagram showing a configuration of the in-vehicle agent server 200 and a part of a configuration of the agent device 100. Hereinafter, the configuration of the in-vehicle agent server 200 and the operations of the in-vehicle agent function unit 150 and the like will be described. Here, the description of physical communication from the agent device 100 to the network NW is omitted.

The in-vehicle agent server 200 includes a communication unit 210. For example, the communication unit 210 is a network interface such as a network interface card (NIC). Further, the in-vehicle agent server 200 includes, for example, a voice recognition unit 220, a natural language processing unit 222, an interaction management unit 224, a network search unit 226, and a response sentence generation unit 228.

These components are implemented, for example, by a hardware processor such as a CPU executing a program (software). Some or all of these components may be implemented by hardware (a circuit including circuitry) such as LSI, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (the non-transitory storage medium) such as a DVD or a CD-ROM and installed when the storage medium is mounted in a drive device.

The in-vehicle agent server 200 includes a storage unit 250. The storage unit 250 is implemented by the various storage devices described above included in the in-vehicle agent server 200. The storage unit 250 stores data and programs of a personal profile 252, a dictionary database (DB) 254, a knowledge base DB 256, a response rule DB 258, and the like. Data and programs such as the personal profile 252, the dictionary DB 254, the knowledge base DB 256, and the response rule DB 258 correspond to the in-vehicle agent application and may be stored in the storage unit 126 provided in the agent device 100.

In the agent device 100, the in-vehicle agent function unit 150 transmits a voice stream or a voice stream subjected to a process such as compression or encoding to the in-vehicle agent server 200. When a voice command for which a local process (a process to be performed without involving the in-vehicle agent server 200) is possible has been recognized, the in-vehicle agent function unit 150 may perform a process requested by the voice command. The voice command for which the local process is possible is a voice command that can be answered by referring to a storage 126 (not shown) included in the agent device 100 or a voice command for controlling the vehicle equipment 50 (for example, a command for turning on the air conditioner or the like). Accordingly, the in-vehicle agent function unit 150 may have some of the functions of the in-vehicle agent server 200.

When the voice stream is acquired, the voice recognition unit 220 performs voice recognition and outputs text information obtained through conversion into text and the natural language processing unit 222 performs semantic interpretation on the text information with reference to the dictionary DB 254. The dictionary DB 254 associates abstract meaning information with text information. The dictionary DB 254 may include list information of synonyms.

The process of the voice recognition unit 220 and the process of the natural language processing unit 222 are not clearly divided into stages and may be performed while affecting each other such that the voice recognition unit 220 corrects a recognition result in response to a processing result of the natural language processing unit 222.

For example, the natural language processing unit 222 generates a command replaced with the standard text information “Today's weather” when a meaning such as “How is the weather today?” or “How is the weather?” has been recognized as a recognition result. Thereby, when the voice of the request has text variations, it is also possible to easily perform a requested interaction. For example, the natural language processing unit 222 may recognize the meaning of the text information using artificial intelligence processing such as a machine learning process using probability or may generate a command based on a recognition result.

The interaction management unit 224 determines details of the speech to the occupant of the vehicle M with reference to the personal profile 252, the knowledge base DB 256, or the response rule DB 258 on the basis of a processing result (a command) of the natural language processing unit 222. The personal profile 252 includes personal information of the occupant, hobbies and preferences, a history of past interactions, and the like stored for each occupant. The knowledge base DB 256 is information that defines relationships between things. The response rule DB 258 is information that defines an operation to be performed by the agent with respect to the command (such as a response or details of equipment control).

The interaction management unit 224 may specify the occupant by performing collation with the personal profile 252 using feature information obtained from the voice stream. In this case, in the personal profile 252, for example, personal information is associated with voice feature information. The voice feature information is, for example, information about how someone speaks such as voice pitch, intonation, and rhythm (a voice pitch pattern of the sound) and feature quantities such as Mel Frequency Cepstrum Coefficients. The voice feature information is, for example, information obtained by allowing the occupant to utter a predetermined word or sentence at the time of initial registration of the occupant and recognizing the uttered voice.

When the command is used to request information capable of being searched for via the network NW, the interaction management unit 224 causes the network search unit 226 to search for the information. The network search unit 226 accesses the various types of web servers 500 via the network NW and acquires desired information. The “information capable of being searched for via the network NW” is, for example, an evaluation result of a general user of a restaurant near the vehicle M or a weather forecast according to the position of the vehicle M on that day.

The response sentence generation unit 228 generates a response sentence so that details of speech determined by the interaction management unit 224 are transferred to the occupant of the vehicle M and transmits the response sentence to the agent device 100. When the occupant is specified to be an occupant registered in the personal profile, the response sentence generation unit 228 may call the name of the occupant or generate the response sentence in a manner of speaking similar to that of the occupant.

When the response sentence is acquired, the in-vehicle agent function unit 150 instructs the voice control unit 118 to perform voice synthesis and output voice. The in-vehicle agent function unit 150 instructs the display control unit 116 to display an image of the agent according to the voice output. In this manner, an agent function in which a virtually appearing agent responds to the occupant of the vehicle M is implemented.

### [General-Purpose Communication Terminal]

FIG. 7 is a diagram showing an example of a configuration of the general-purpose communication terminal MT including the terminal agent device 300. The general-purpose communication terminal MT is, for example, a communication device carried by a user such as a smartphone or a tablet, and includes a microphone 332, a touch panel 334, a speaker 336, and a terminal agent device 300. In the general-purpose communication terminal MT, a general-purpose application program (a general-purpose agent application) for supporting a service including a voice response is installed. The general-purpose communication terminal MT functions as the terminal agent device 300 when the general-purpose agent supplement is activated, a user agent (UA) such as the general-purpose agent application or a browser is operated, and a service including a voice response is supported. The general-purpose agent application installed in the general-purpose communication terminal MT is a type of application different from the in-vehicle agent application included in the agent device 100.

For example, the microphone 332 is a sound collection unit provided at the end of the outside surface of a housing of the general-purpose communication terminal MT and configured to collect voice uttered toward the general-purpose communication terminal MT. For example, the touch panel 334 is a device provided on the outside front of the housing of the general-purpose communication terminal MT and configured to display various information and receive an operation of the user. For example, the speaker 336 is a device provided at the end of the outside surface of the housing of the general-purpose communication terminal MT and configured to output a sound from the general-purpose communication terminal MT.

The terminal agent device 300 includes a management unit 310, a terminal agent function unit 350, a terminal-mounted communication unit 352, a vehicle-to-vehicle communication unit 354, a terminal radio wave intensity measurement unit 392, and a terminal communication amount measurement unit 394. The management unit 310 functions by executing a program such as an operating system (OS) or middleware. The management unit 310 includes a sound processing unit, a WU determination unit, and various types of control units similar to the management unit 110 of the agent device 100. The management unit 310 performs sound processing on the input sound so that the sound processing unit is in a state suitable for recognizing a wake-up word preset for the terminal agent device 300 and various types of processes such as a WU determination, sound processing, display control, and voice control in the WU determination unit and various types of control units are performed. The WU word used for the WU determination of the terminal agent device may be different from or the same as the WU word used for the WU determination of the agent device 100.

The terminal agent function unit 350 is mounted in the terminal agent device 300. The terminal agent function unit 350 causes the agent to appear in cooperation with the terminal agent server 400 and provides a service including a voice response in accordance with speech of the user. Further, the terminal agent function unit 350 cooperates with the terminal agent server 400 to generate response information such as a voice response according to the information transmitted by the agent device 100. The in-vehicle agent function unit 150 and the terminal agent function unit 350 can perform communication within the vehicle M. The in-vehicle agent function unit 150 and the terminal agent function unit 350 may be configured to be able to perform communication via each other's parent server.

The terminal-mounted communication unit 352 has a function of accessing a network NW using, for example, a cellular network or a Wi-Fi network. The terminal-mounted communication unit 352 transmits information generated by the terminal agent function unit 350 to the terminal agent server 400 and receives information transmitted by the terminal agent server 400.

For example, the vehicle-to-vehicle communication unit 354 has a function that can use short-range wireless communication such as Bluetooth (registered trademark). The vehicle-to-vehicle communication unit 354 receives information transmitted by the agent device 100 and transmits information generated by the terminal agent function unit 350 and the like to the agent device 100. The in-vehicle agent function unit 150 and the terminal agent function unit 350 transmit and receive information through short-range wireless communication.

The terminal radio wave intensity measurement unit 392 has a function of measuring a radio wave intensity of the general-purpose communication terminal MT (hereinafter referred to as a terminal radio wave intensity) around the general-purpose communication terminal MT. The terminal radio wave intensity measurement unit 392 outputs information of the measured radio wave intensity to the management unit 310. The terminal communication amount measurement unit 394 has a function of measuring an amount of communication of the general-purpose communication terminal MT. The terminal communication amount measurement unit 394 outputs information of the measured amount of communication to the management unit 310. The management unit 310 transmits the output information of the radio wave intensity and the output information of the amount of communication to the agent device 100 as the information of the terminal intensity and the amount of terminal communication, respectively.

### [Terminal Agent Server]

Although the terminal agent server 400 has, for example, a configuration similar to that of the in-vehicle agent server 200, data and programs such as a personal profile, a dictionary DB, a knowledge base DB, and a response rule DB stored in a storage unit correspond to a general-purpose agent application. When a voice stream or a voice stream subjected to a process such as compression or encoding has been transmitted to the terminal agent server 400, the terminal agent server 400 performs a process similar to a process when the in-vehicle agent function unit 150 transmits information thereof to the in-vehicle agent server 200. The terminal agent server 400 determines details of speech, generates a response sentence so that the determined details of the speech are transferred to the user, and transmits the response sentence to the terminal agent device 300.

When the terminal agent device 300 receives the response sentence, the terminal agent function unit 350 instructs the management unit 310 to perform voice synthesis and output voice. Alternatively, the terminal agent device 300 generates response information on the basis of the received response sentence and transmits the generated response information to the agent device 100 mounted in the vehicle M using the vehicle-to-vehicle communication unit 354. When the response information is received, the agent device 100 instructs the voice control unit 118 to perform voice synthesis using the in-vehicle agent function unit 150 and output the response sentence by voice.

### [Process in Agent Device]

Next, an example of a process in the agent device 100 will be described. The agent device 100 starts communication with the in-vehicle agent server 200 when the occupant of the vehicle M starts an interaction or transmits information output by the in-vehicle agent function unit 150 to the general-purpose communication terminal MT.

The terminal agent device 300 of the general-purpose communication terminal MT starts communication with the terminal agent server 400, acquires a response, and provides the response to the agent device 100. The agent device 100 presents the response obtained from the in-vehicle agent server 200 or the terminal agent server 400 to the occupant in the form of voice output or image display.

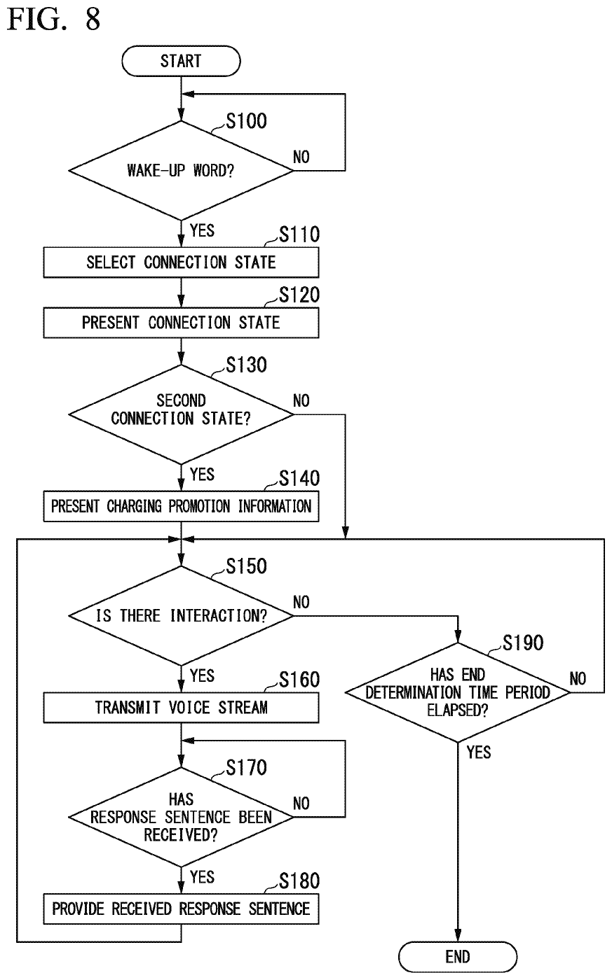

FIG. 8 is a flowchart showing an example of a flow of a process to be executed in the agent device 100. In the agent device 100, the WU determination unit 114 detects a voice section of voice uttered by the occupant and determines whether or not text information obtained by converting the detected voice section into text is a wake-up word (a WU word) (step S100).

When it is determined that the text information is a wake-up word, the selection unit 122 selects the connection state of the agent device 100 from the first connection state and the second connection state (step S110). The connection state of the agent device 100 is selected on the basis of information such as a location of the vehicle M, a radio wave intensity, and an amount of communication. The selection of the connection state of the agent device 100 can be performed by various methods. The selection of the connection state of the agent device 100 will be sequentially described below. The selection unit 122 determines that the agent server to which the agent device 100 transmits the voice stream is the in-vehicle agent server 200 or the terminal agent server 400 by selecting the connection state of the agent device 100.

The agent server of a connection destination at the time of the first connection state is the in-vehicle agent server 200 and the agent server of a connection destination at the time of the second connection state is the terminal agent server 400. For example, when the selection unit 122 selects the first connection state, the agent server that transmits the voice stream becomes the in-vehicle agent server 200. When the selection unit 122 selects the second connection state, the agent server that transmits the voice stream becomes the terminal agent server 400.

Subsequently, the information providing unit 124 presents information of the connection state of the agent device 100 to the user (step S120). For example, the information providing unit 124 outputs information of the connection state of the agent device 100 to the display control unit 116 and the voice control unit 118. The display control unit 116 controls the display and operation device 20 on the basis of the output information of the connection state of the agent device 100 and causes the first display 22 or the second display 24 to display a mark or a name of the agent server of the connection destination according to the current connection state. The voice control unit 118 causes the speaker unit 30 to output voice of the name or the like of the agent server of the connection destination according to the current connection state.

Subsequently, the information providing unit 124 determines whether or not the connection state of the agent device 100 is the second connection state (step S130). When it is determined that the connection state of the agent device 100 is the second connection state, the information providing unit 124 presents information for promoting the charging of the general-purpose communication terminal MT to the occupant (step S140). For example, the information providing unit 124 outputs the information for promoting the charging of the general-purpose communication terminal MT to the display control unit 116 and the voice control unit 118. The display control unit 116 controls the display and operation device 20 on the basis of the output information for promoting the charging of the general-purpose communication terminal MT and causes the first display 22 or the second display 24 to display the information for prompting the charging of the general-purpose communication terminal MT. The voice control unit 118 causes the speaker unit 30 to output voice for prompting the charging of the general-purpose communication terminal MT. When it is determined that the connection state of the agent device 100 is not the second connection state, the agent device 100 proceeds to step S150 as it is.

Subsequently, the in-vehicle agent function unit 150 determines whether or not there has been an interaction with the occupant (step S150). When it is determined that there has been an interaction with the occupant, the in-vehicle agent function unit 150 transmits a voice stream to the agent server of the connection destination in the connection state determined by the selection unit 122 (step S160).

When the voice stream is transmitted to the in-vehicle agent server 200, the agent device 100 directly transmits the voice stream to the in-vehicle agent server 200 using the in-vehicle communication device 60. When the voice stream is transmitted to the terminal agent server 400, the agent device 100 temporarily transmits the voice stream to the general-purpose communication terminal MT and the terminal agent device 300 of the general-purpose communication terminal MT transmits the voice stream to the terminal agent server 400. In this manner, when the voice stream is transmitted to the terminal agent server 400, the agent device 100 transmits the voice stream via the general-purpose communication terminal MT.

Subsequently, the agent device 100 determines whether or not a response sentence transmitted by the agent server of the connection destination has been received (step S170). When it is determined that a response sentence transmitted from the agent server of the connection destination has not been received, the agent device 100 iterates the process of step S170 before the response sentence is received. When the response sentence has not been received even though a period of appropriate response time has elapsed while step S170 is iterated, the process shown in FIG. 8 may be ended as it is.

When it is determined that a response sentence has been received by the agent server of the connection destination, the information providing unit 124 generates response information corresponding to the response sentence, outputs the response information to the display control unit 116 and the voice control unit 118, and provides the response sentence to the user (step S180). Subsequently, returning to step S150, the in-vehicle agent function unit 150 iterates the process of determining whether or not there has been an interaction with the occupant.

When it is determined that there has been no interaction with the occupant in step S150, the in-vehicle agent function unit 150 measures a time period for which there has been no interaction and determines whether or not the measured time period is greater than or equal to an end determination time period (step S190). The end determination time period can be set to any time period. For example, the end determination time period may be a short time period such as 5 seconds or 10 seconds or may be a long time period such as 30 seconds or 1 minute, or even 30 minutes.

When it is determined that the end determination time period has not elapsed, the agent device 100 returns to step S150 and the in-vehicle agent function unit 150 iterates the process of determining whether or not there has been an interaction with the occupant. The agent device 100 determining that the end determination time period has elapsed ends the process shown in FIG. 8.

### [Aspects of Selection of Connection State of Agent Device 100]

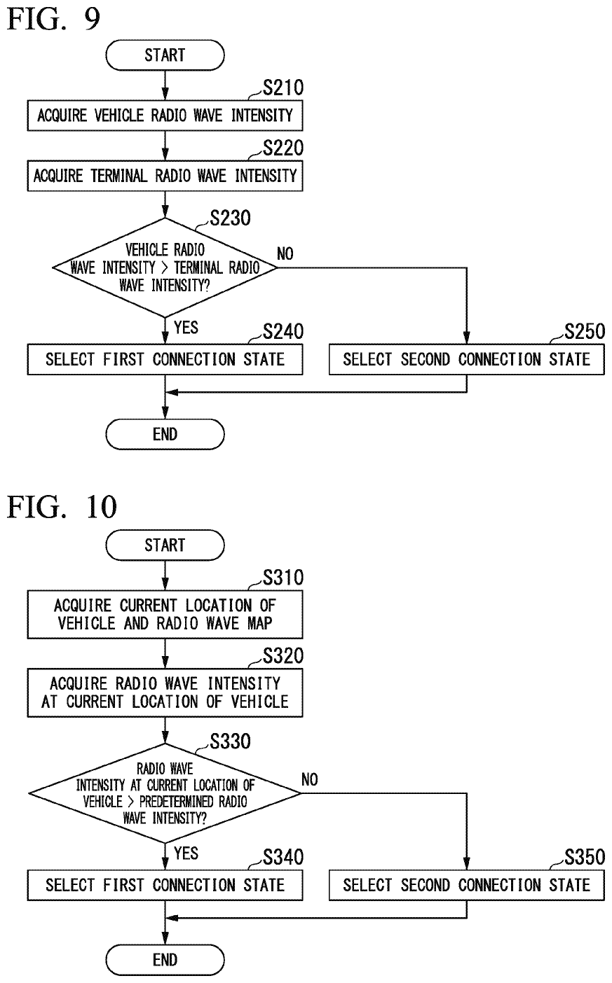

Next, aspects of selection of the connection state of the agent device 100 will be described. FIGS. 9 to 12 are flowcharts showing an example of a flow of a process to be executed in the agent device 100. In FIGS. 9 to 12, an example of the selection of the connection state to be executed in step S120 of FIG. 8 will be mainly described. The following connection aspects may be selected in combination.

### [Aspect (1) of Selection of Connection State of Agent Device 100]

First, a first aspect of the selection of the connection state of the agent device 100 will be described. In the first aspect, the agent device 100 selects one of the first connection state and the second connection state having a higher radio wave intensity as a state of a connection to the network NW.

The acquisition unit 120 acquires a vehicle radio wave intensity transmitted by the radio wave intensity measurement device 92 (step S210). Subsequently, the acquisition unit 120 acquires a terminal radio wave intensity measured by the terminal radio wave intensity measurement unit 392 and transmitted by the general-purpose communication terminal MT (step S220). The selection unit 122 compares the vehicle radio wave intensity and the terminal radio wave intensity acquired by the acquisition unit 120 and determines whether or not the vehicle radio wave intensity is higher (step S230).

As a result, when it is determined that the vehicle radio wave intensity is higher, the selection unit 122 selects the first connection state as the connection state of the agent device 100 (step S240). On the other hand, when it is determined that the vehicle radio wave intensity is not higher (the vehicle radio wave intensity is less than or equal to the terminal radio wave intensity), the selection unit 122 selects the second connection state as the connection state of the agent device 100 (step S250). Thus, the agent device 100 ends the process shown in FIG. 9.

In this manner, in the first aspect of the selection of the connection state of the agent device 100, the selection unit 122 selects the connection state of the agent device 100 on the basis of a comparison result of comparing the vehicle radio wave intensity with the terminal radio wave intensity. Specifically, the selection unit 122 compares the vehicle radio wave intensity with the terminal radio wave intensity and selects a connection state in which the agent device 100 is connected to the agent server having the higher radio wave intensity. Thus, it is possible to make a connection to the agent server with a high radio wave intensity, thereby contributing to providing a stable service.

### [Aspect (2) of Selection of Connection State of Agent Device 100]

Next, a second aspect of the selection of the connection state of the agent device 100 will be described. In the second aspect, the agent device 100 selects one of the first connection state and the second connection state according to a location of the vehicle M as the state in which the in-vehicle agent function unit 150 is connected to the network NW.

The acquisition unit 120 acquires location information of the vehicle M and a radio wave intensity map included in map information transmitted by the navigation device 40 (step S310). Subsequently, the acquisition unit 120 acquires the radio wave intensity at the location of the vehicle M with reference to the information of the location of the vehicle M in a radio wave intensity map (step S320).

Subsequently, the selection unit 122 determines whether or not the radio wave intensity at the location of the vehicle M exceeds a predetermined radio wave intensity (step S330). The predetermined radio wave intensity may be any preset radio wave intensity, and the predetermined radio wave intensity may be set to any value. For example, the predetermined radio wave intensity may be set to 0 or may be set to a value exceeding 0. The predetermined radio wave intensity may be changed on the basis of a predetermined condition, for example, a clock time, a geographical condition, or the like.

As a result, when it is determined that the radio wave intensity at the location of the vehicle M exceeds the predetermined radio wave intensity, the selection unit 122 selects the first connection state as the connection state of the agent device 100 (step S340). On the other hand, when it is determined that the radio wave intensity at the location of the vehicle M does not exceed the predetermined radio wave intensity (the radio wave intensity at the location of the vehicle M is less than or equal to the predetermined radio wave intensity), the selection unit 122 selects the second connection state as the connection state of the agent device 100 (step S350). Thus, the agent device 100 ends the process shown in FIG. 10.

In this manner, in the second aspect of selection of the connection state of the agent device 100, the selection unit 122 selects the connection state of the agent device 100 on the basis of the radio wave intensity at the location of the vehicle M. Specifically, the selection unit 122 selects a connection state in which the agent device 100 is connected to the agent server according to whether or not the radio wave intensity at the location of the vehicle M exceeds a predetermined radio wave intensity. Thus, it is possible to make a connection to the agent server with a high radio wave intensity, thereby contributing to providing a stable service.

Instead of or in addition to determining whether or not the radio wave intensity at the location of the vehicle M exceeds a predetermined radio wave intensity, the connection state of the agent device 100 may be selected on the basis of a comparison result between the radio wave intensity at the location of the vehicle M and the terminal radio wave intensity. For example, the general-purpose communication terminal MT may store a terminal radio wave intensity map and select the connection state of the agent device 100 on the basis of a result of comparing radio wave intensities acquired with reference to the location of the vehicle M in the vehicle radio wave intensity map and the terminal radio wave intensity map. The connection state of the agent device 100 may be selected on the basis of a result of comparing the vehicle radio wave intensity and the radio wave intensity acquired with reference to the location of the vehicle M in the vehicle radio wave intensity map and the terminal radio wave intensity map.

### [Aspect (3) of Selection of Connection State of Agent Device 100]

Next, a third aspect of selection of the connection state of the agent device 100 will be described. In the third aspect, the agent device 100 selects one of the first connection state and the second connection state as the state in which the in-vehicle agent function unit 150 is connected to the network NW on the basis of an amount of communication in the first connection state. Further, when the amount of communication in the first connection state exceeds a predetermined amount of communication, the agent device 100 selects the second connection state as a state in which the in-vehicle agent function unit 150 is connected to the network NW.

The acquisition unit 120 acquires information of the amount of communication of the in-vehicle communication device 60 transmitted by the communication amount measurement device 94 (step S410).

Subsequently, the selection unit 122 determines whether or not the amount of communication of the in-vehicle communication device 60 exceeds the predetermined amount of communication (step S420). The predetermined amount of communication may be any preset amount of communication or the predetermined amount of communication may be set to any value. For example, the predetermined amount of communication may be the same as an amount of communication based on a contract between the user and the provider of the agent system or may be less than this amount of communication.

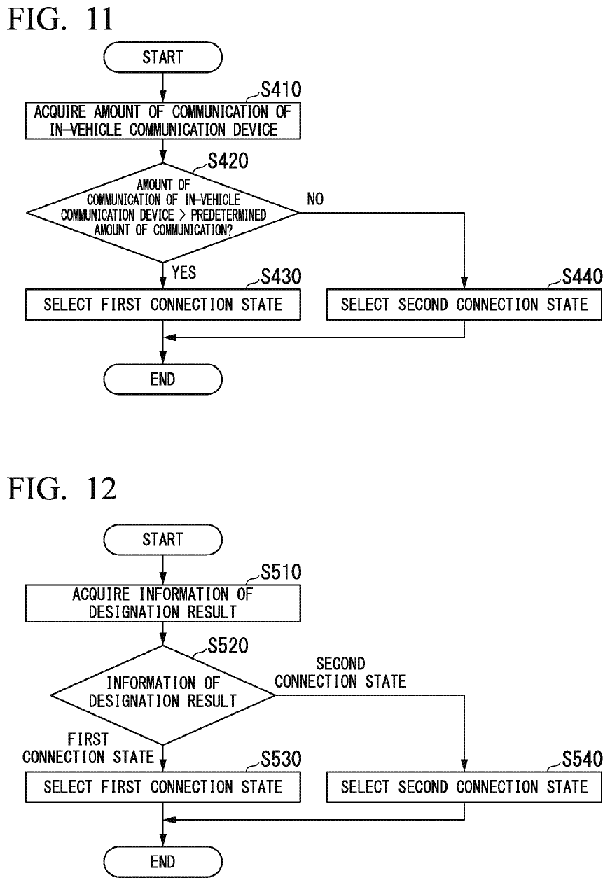

As a result, when it is determined that the amount of communication of the in-vehicle communication device 60 exceeds the predetermined amount of communication, the selection unit 122 selects the first connection state as the connection state of the agent device 100 (step S430). On the other hand, when it is determined that the amount of communication of the in-vehicle communication device 60 does not exceed the predetermined amount of communication (the amount of communication of the in-vehicle communication device 60 is less than or equal to the predetermined amount of communication), the selection unit 122 selects the second connection state as the connection state of the agent device 100 (step S440). Thus, the agent device 100 ends the process shown in FIG. 11.

In this manner, in the third aspect of the selection of the connection state of the agent device 100, the selection unit 122 selects the connection state of the agent device 100 on the basis of the amount of communication of the in-vehicle communication device 60. Specifically, the selection unit 122 selects a connection state in which the agent device 100 is connected to the agent server according to whether or not the amount of communication of the in-vehicle communication device 60 exceeds the predetermined amount of communication. Thus, it is possible to minimize the amount of communication in the vehicle M and prevent the communication of the vehicle M in which the amount of communication exceeds a limit value.

Instead of or in addition to determining whether or not the radio wave intensity at the location of the vehicle M exceeds a predetermined radio wave intensity, the connection state of the agent device 100 may be selected on the basis of a result of comparison with an amount of communication with the terminal agent server 400 in the general-purpose communication terminal MT. For example, the connection state of the agent device 100 may be selected on the basis of a comparison result between the amount of communication with the terminal agent server 400 in the general-purpose communication terminal MT and a predetermined amount of communication.

### [Aspect (4) of Selection of Connection State of Agent Device 100]

Next, a fourth aspect of selection of the connection state of the agent device 100 will be described. In the fourth aspect, the agent device 100 selects the first connection state and the second connection state on the basis of the designation of the user as a state in which the in-vehicle agent function unit 150 is connected to the network NW.

The acquisition unit 120 acquires information of a designation result transmitted by the display and operation device 20 (step S510). Subsequently, the selection unit 122 determines whether or not the connection state designated by the information of the designation result acquired by the acquisition unit 120 is the first connection state or the second connection state (step S520).

As a result, when it is determined that the connection state designated by the information of the designation result acquired by the acquisition unit 120 is the first connection state, the selection unit 122 selects the first connection state as the connection state of the agent device 100 (step S530). On the other hand, when it is determined that the connection state designated by the information of the designation result acquired by the acquisition unit 120 is the second connection state, the selection unit 122 selects the second connection state as the connection state of the agent device 100 (step S540). Thus, the agent device 100 ends the process shown in FIG. 12.

In this manner, in the fourth aspect of the selection of the connection state of the agent device 100, the selection unit 122 selects the connection state of the agent device 100 on the basis of the connection state designated by the information of the designation result acquired by the acquisition unit 120. Because the connection state designated by the information of the designation result is the connection state designated by the occupant, the selection unit 122 selects the connection state in which the agent device 100 is connected to the agent server on the basis of the designation of the occupant. Thus, a service can be provided from the agent intended by the user.

According to the above-described first embodiment, the agent device 100 transmits and receives information to and from the agent server in the first connection state implemented via the in-vehicle communication unit 152 or the second connection state implemented via the terminal communication unit 154. Thus, because a plurality of communication means, here two communication means, are used and communication by another communication means can be performed even if a malfunction occurs in one communication means, it is possible to provide more reliable support for the user.

In the second connection state, the agent device 100 transmits and receives information to and from the agent server via the general-purpose communication terminal MT. Thus, the amount of communication of the vehicle M in which the agent device 100 is mounted can be further reduced. Therefore, a limit value of the amount of communication of the vehicle M can be set to be small.

The agent device 100 presents whether the connection state is the first connection state or the second connection state to the user according to the name of the agent server of the connection destination or the like. Thus, because the user can recognize the agent in use, for example, an agent desired to be used can be easily determined. When the connection state is the second connection state, the agent device 100 promotes charging of the general-purpose communication terminal MT. Thus, insufficient charging of the general-purpose communication terminal MT can be minimized by continuing the second connection state.

### Second Embodiment

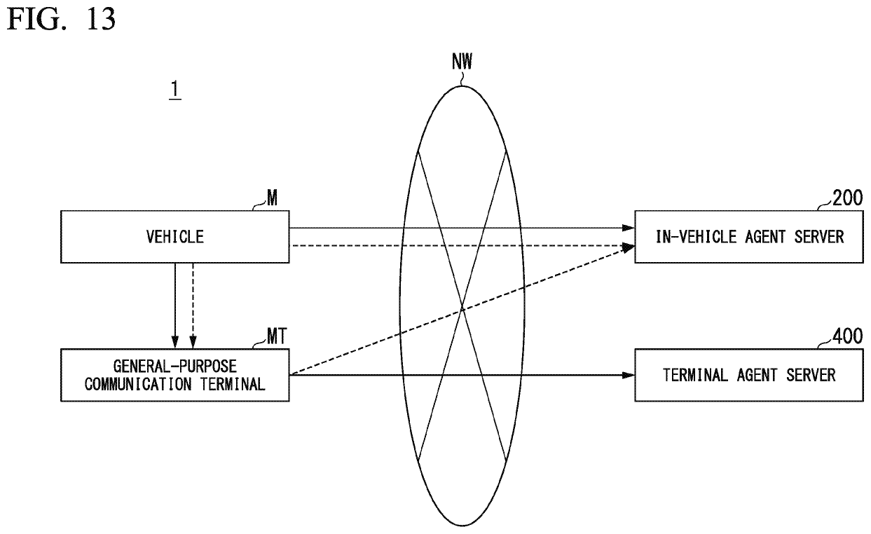

Hereinafter, a second embodiment will be described. In a general-purpose communication terminal MT of the second embodiment, an application which is of the same type as an in-vehicle agent application provided in an agent device 100 (hereinafter, an application which is of the same type as that of an in-vehicle agent) and in which login using a user ID that is the same as a user ID used for login to the agent device 100 is possible is installed. For example, the user can receive services using the same agent server (an in-vehicle agent server 200) with a common account both when he or she logs in to the agent device 100 and when he or she logs in to a terminal agent device 300. The general-purpose communication terminal MT functions as the terminal agent device 300 when the application which is of the same type as that of the in-vehicle agent is activated. FIG. 13 is a diagram showing an example of a state in which information is transmitted and received between the agent device 100 and the agent server.

In the agent system 1 of the first embodiment, as indicated by a solid line in FIG. 13, the agent device 100 transmits and receives information directly to and from the in-vehicle agent server 200 or transmits and receives information to and from the terminal agent server 400 via the general-purpose communication terminal MT. On the other hand, in the agent system 1 of the second embodiment, as indicated by a broken line in FIG. 13, the agent device 100 transmits and receives information directly to and from the in-vehicle agent server 200 or transmits and receives information to and from the in-vehicle agent server 200 via the general-purpose communication terminal MT.

When information is transmitted and received to and from the in-vehicle agent server 200 via the general-purpose communication terminal MT, the agent device 100 receives the information transmitted by the in-vehicle agent server 200 via the application which is of the same type as the in-vehicle agent application installed in the general-purpose communication terminal MT. In the agent system 1 of the second embodiment, because the general-purpose agent application and the terminal agent server 400 are unnecessary, it is possible to transmit and receive information between the agent device 100 and the in-vehicle agent server 200 via the general-purpose communication terminal MT even though the general-purpose communication terminal MT does not have an agent function.

The vehicle M in which the agent device 100 of the above second embodiment is mounted can transmit and receive information to and from the in-vehicle agent server 200 via the general-purpose communication terminal MT so that the service of the agent can be received. Therefore, the user can provide more reliable support and can receive a service using the in-vehicle agent application in a state in which the amount of communication is reduced.

Although there is only one in-vehicle agent server in each of the above embodiments, a plurality of in-vehicle agent servers may be provided. In this case, it is only necessary to provide an agent function unit corresponding to each of the plurality of agent servers in the agent device 100. Among the plurality of agent function units, for example, an agent function unit exclusively connected to an in-vehicle communication device 60 or the general-purpose communication terminal MT may be provided. The plurality of agent function units may be configured to include, for example, those to which authority to control vehicle equipment 50 is given and those to which the authority is not given.

In selecting the first connection state and the second connection state, the selection unit 122 preferentially selects one of the first connection state and the second connection state and the connection state to which the priority is not given may be selected when some condition is satisfied. For example, the selection unit 122 may be configured to preferentially select the first connection state and select the second connection state when an amount of communication of the vehicle M exceeds a predetermined amount of communication. For example, in an environment in which the second connection state is easily adopted, for example, when a user (an occupant) can use the amount of communication of the general-purpose communication terminal MT without any fixed amount, the selection unit 122 may be configured to preferentially select the second connection state.

Although modes for carrying out the present invention have been described using embodiments, the present invention is not limited to the embodiments, and various modifications and substitutions can also be made without departing from the scope and spirit of the present invention.

What is claimed is:

1. An agent device comprising:
an in-vehicle agent function unit mounted in a vehicle and configured to provide a service including causing an output unit to output a voice response in accordance with speech of a user;
an in-vehicle communication unit configured to cause the in-vehicle agent function unit to be connected to a network via an in-vehicle communication device; and
a terminal communication unit configured to cause the in-vehicle agent function unit to be connected to the network via a general-purpose terminal,
wherein a state in which the in-vehicle agent function unit is connected to the network is selected from a first connection state implemented via the in-vehicle communication unit and a second connection state implemented via the terminal communication unit.

2. The agent device according to claim 1,
wherein a terminal agent function unit configured to provide a service including causing an output unit to output a voice response using hardware of the general-purpose terminal in accordance with the speech of the user is mounted in the general-purpose terminal, and
wherein the terminal communication unit causes the in-vehicle agent function unit to be connected to the network via the terminal agent function unit of the general-purpose terminal.

3. The agent device according to claim 2, wherein the in-vehicle agent function unit and the terminal agent function unit are able to perform communication within the vehicle or via each other's parent server.

4. The agent device according to claim 3, wherein the in-vehicle agent function unit and the terminal agent function unit transmit and receive information through short-range wireless communication.

5. The agent device according to claim 1, wherein information provided via the network is provided to the in-vehicle agent function unit via the terminal communication unit when the second connection state has been selected.

6. The agent device according to claim 1, wherein one of the first connection state and the second connection state having a higher radio wave intensity is selected.

7. The agent device according to claim 1, wherein one of the first connection state and the second connection state is selected in accordance with a location of the vehicle.

8. The agent device according to claim 1, wherein one of the first connection state and the second connection state is selected on the basis of an amount of communication of the first connection state.

9. The agent device according to claim 8, wherein the second connection state is selected when the amount of communication of the first connection state exceeds a predetermined amount of communication.

10. The agent device according to claim 1, wherein the first connection state and the second connection state are selected on the basis of designation of the user.

11. The agent device according to claim 1, wherein it is presented whether the state in which the in-vehicle agent function unit is connected to the network is the first connection state or the second connection state.

12. The agent device according to claim 1, wherein the user is prompted to charge the general-purpose terminal when the second connection state is selected as the state in which the in-vehicle agent function unit is connected to the network.

13. A method of controlling an agent device, the method comprising:
activating, by a computer, an in-vehicle agent function unit mounted in a vehicle and a terminal agent function unit mounted in a general-purpose terminal;
enabling, by the computer, the in-vehicle agent function unit to be connected to a network via an in-vehicle communication device;
enabling, by the computer, the in-vehicle agent function unit to be connected to the network via the general-purpose terminal; and
selecting, by the computer, a state in which the in-vehicle agent function unit is connected to the network from a first connection state implemented via an in-vehicle communication unit and a second connection state implemented via a terminal communication unit.

14. A computer-readable non-transitory storage medium storing a program for causing a computer to execute:
a process of activating an in-vehicle agent function unit mounted in a vehicle and a terminal agent function unit mounted in a general-purpose terminal;
a process of enabling the in-vehicle agent function unit to be connected to a network via an in-vehicle communication device;
a process of enabling the in-vehicle agent function unit to be connected to the network via the general-purpose terminal; and
a process of selecting a state in which the in-vehicle agent function unit is connected to the network from a first connection state implemented via an in-vehicle communication unit and a second connection state implemented via a terminal communication unit.
